(19) United States
(12) Patent Application Publication
(10) Pub. No.: US 2014/0002237 A1
(43) Pub. Date: Jan. 2, 2014

(54) Apparatus and Method for Vehicle Operation Using Biometric Fingerprint identification

(71) Applicant: Fist Enterprises, LLC, Boca Raton, FL (US)

(72) Inventors: Joseph Infante, West Palm Beach, FL (US); Todd Newberry, Mansfield, OH (US); Dale Norwood, Galion, OH (US)

(21) Appl. No.: 13/918,717

(22) Filed: Jun. 14, 2013

Related U.S. Application Data
(60) Provisional application No. 61/659,782, filed on Jun. 14, 2012.

(51) Int. Cl. B60R 25/10

(52) U.S. Cl. CPC B60R 25/10
USPC 340/5.32; 340/5.53

(57) ABSTRACT

Disclosed is a fingerprint authentication system having a particular benefit for use in protecting vehicles. The system includes a wireless handheld programmer for easy setup and configuration of a multifactor security authentication console having multicolor LED indicator lights that provide programming and user interface feedback by universal symbols. The system is electrically coupled to a vehicle by use of a relay allowing most any vehicle on/off function to be controlled. Once the operator's identity has been authenticated, the device allows operation of the vehicle. A valet mode is provided wherein the unit can be deactivated or programmed to allow a single user. A sensor module operates as the swipe device allowing for the inconspicuous placement on most any vehicle.

### PRIORITY CLAIM

In accordance with 37 C.F.R. 1.76, a claim of priority is included in an Application Data Sheet filed concurrently herewith. Accordingly, the present invention claims priority under 35 U.S.C. §119(e), 120, 121, and/or 365(c) to U.S. Provisional Patent Application No. 61/659,782, entitled “BIOMETRIC FINGERPRINT IDENTIFICATION” filed Jun. 14, 2012. The contents of which the above referenced application is incorporated herein by reference.

### FIELD OF THE INVENTION

The invention is related to the security field and in particular to a biometric fingerprint identification device and method of programming providing a security system for use on vehicles.

### BACKGROUND OF THE INVENTION

The revolutionary growth of the transportation industry has been constant, despite historic changes in the economy and the peaks and valleys of modern industry. The U.S. Bureau of Transit statistics state that, as of 2008, there were approximately 255,917,664 registered vehicles operating in the United States, and this number was projected to increase by 3.69 million vehicles per year. In addition, Coast Guard statistics indicate 12,438,926 boats registered as of 2009. Vehicles are property and the loss of such property may have a monetary measure but the inconvenience and emotional loss may be incalculable. The need for security systems to protect these investments is well known.

The present invention relates generally to personal identification or verification systems and, more particularly, to systems that automatically verify a person's identity before granting access to a vehicle. Traditionally, a key lock combination has been used to limit access to a vehicle on the theory that only a person with a right to access the vehicle will have access to the required key. Most every vehicle known is protected by a key lock and may include an alarm system which can be activated using an infrared or radio frequency transmitter carried by the vehicle owner. This can result in the vehicle owner carrying a key and a transmitter. If the vehicle owner has multiple vehicles then multiple keys and transmitters could be required. Should the owner of the vehicle misplace their keys the vehicle will not operate. Further, if only the mechanical key is used for protection the vehicle is more vulnerable to theft.

While most current automobiles include elaborate theft prevention systems, such systems are typically a security system wherein a transmitter is used to transmit RF or IR signals to a vehicle mounted system for door access and to activate and deactivate intrusion alarms. Once an operator is within the vehicle, the operator must resort to a mechanical key to start the car. Keyless ignition systems are also available; however the owner of the vehicle is then relying on the security system alone for protection of the vehicle.

Accordingly, there is a widely felt need for a more reliable technique for accessing and using automobiles. Ideally, the technique should positively verify the identity of the person seeking access, should provide access to all the car's features, and should eliminate the need to carry multiple keys and fobs, or to memorize combinations or passwords. Another desirable goal is that the technique should operate rapidly enough that it does not significantly delay a person's access to and use of the vehicle, and function with all types, makes, and models of vehicle. The present invention satisfies all of these needs.

The most common method of biometric fingerprint identification is the use of an optical scan. An optical scan takes a picture of the fingerprint and uses comparison software to verify the fingerprint image against a known, or previously entered, fingerprint.

Prior art references include U.S. Pat. No. 5,686,765 which discloses a system for enabling an ignition system and may include a fingerprint reader or eyeball scanner to activate the ignition system of an automotive vehicle. U.S. Pat. No. 5,448,659 discloses a wave guide-type image transmission device using an image of a fingerprint or palmprint. U.S. Pat. No. 6,100,811 discloses an apparatus for controlling a vehicle wherein a two dimensional image of the fingerprint will adjust the automobile settings to the user's preferences. U.S. Pat. No. 5,598,474 discloses a process for encrypting a fingerprint onto an identification card. U.S. Pat. No. 5,523,746 discloses an identification system adapted for use in an electronic key system. U.S. Pat. No. 5,633,947 discloses a method and apparatus for autocorrelation of optical fingerprint images. U.S. Pat. No. 6,144,293 discloses a procedure for operating a security system whereby a transmitter unit scans a user's fingerprint before unlocking a security device. U.S. Pat. No. 6,462,657 discloses an apparatus utilizing a virtual capacitor to detect an intrusion. U.S. Pat. No. 6,927,668 discloses a vehicle security system utilizing the image of a fingerprint to identify and authorize a user to operate the vehicle. U.S. Pat. No. 5,325,442 discloses a capacitive sensing device to create a two dimensional or three dimensional profile of a fingerprint. U.S. Pat. No. 5,920,640 and U.S. Pat. No. 6,069,970 disclose a fingerprint and token sensor for generating signals related to a fingerprint.

Each of these systems includes various fingerprint identification techniques. However, there remains a widely felt need for a more reliable technique for accessing a vehicle. Ideally, the technique will positively verify the identity of the person seeking access by use of fingerprint identification to provide access and eliminate the poor security provided by conventional keys. The technique should also allow an authorized user the ability to temporarily authorize others, such as a mechanic, friend, or valet to operate the vehicle if necessary.

### SUMMARY OF THE INVENTION

Disclosed is an apparatus and method for vehicle operation using a fingerprint authentication system for selectively enabling a vehicle. The system consists of a programming sequence that provides a high level of security in a compact device that is simple to install. A wireless handheld programmer allows for ease of configuring a multifactor security authentication console that employs multicolor LED indicator lights to provide ease of enrollment by universal symbols which can be understood language interpretation.

The security system is electrically coupled to the operating system of a vehicle. A sensor module having a narrow slit like detection window measures passive capacitance resistance of a finger swiped across the sensor window to generate a biometric profile of a finger of an operator and then that profile is checked against a list of registered biometric profiles to authenticate the operator. The swipe technology requires a live finger movement for detection purposes. Once the operator's identity has been authenticated, the device allows operation of the electrical starter or the body control module for either starting of an engine or otherwise operating of a vehicle. The authentication system disclosed can identify up to 24 fingerprints allowing multiple users to be authorized to operate the vehicle. Additional member can be used to store fleet operation of a vehicle, including community airplanes used in a flight school. A Valet Mode is provided wherein an authorized user can deactivate the unit for a period of time to allow anyone to start the vehicle, such as when the vehicle is left with a valet or left for servicing.

An objective of the invention is to provide a fingerprint authentication and keyless entry device for electric and motorized vehicles and motor sports equipment. The device connects to the electrical starter and/or the body control module that allows the operator or a vehicle, and once the operator's identity is authenticated, the device allows the vehicle to be started. In one embodiment, the device can replace the key operation used to start an conventional engine.

Another objective of the invention is to provide a complete fingerprint authentication system and access control system wherein only authorized users can start the vehicle. The access control system can be used to protect the vehicle from the temptation of joyrides, protect the vehicle from unlawful access, or otherwise secure the vehicle without the complication of keeping track of keys.

Still another objective of the invention is to provide the use of a passive capacitance resistance scanning method for fingerprint capture, utilizing a “live” fingerprint and a “swipe” input method. Such a method being capable of preventing false readings by known techniques such as fingerprint powder, gummy bears, pictures of an authorized print, or wax and silicone molds and having a false acceptance rate of only 1 in 1.4 million.

Yet still another objective of the invention is to provide a Valet Mode that provides a security system option for when non-authorized users need to access the vehicle, such as when the vehicle needs servicing or when somebody needs access to the vehicle for only a limited time like a valet driver.

Another objective of the invention is to provide a fingerprint authentication system that can be easily installed, by those skilled in the art that are capable of installing an automobile stereo or conventional automobile alarm, on any kind of vehicle, such as: automobiles, trucks, boats, yachts, planes, all-terrain vehicles, quad runners, dirt bikes, golf carts, jet skis, scooters, electric bicycles, motorcycles, fleet vehicles, snowmobiles, and so forth.

Another objective of the invention is to be vehicle agnostic; to operate on any vehicle regardless of type, make, or model. To achieve this the user may select one of five modes of operation to control the start process: a times start mode with automatic activation of the starting system, a tachometer input with automatic activation of the starting system, a voltage input with automatic activation of the starting system, a timed start mode that permits manual activation of the starting system, and the invention may function as a normally closed switch for user discretion application.

Another objective of the invention is to interface, without user intervention, with all major vehicle electrical voltages. The invention will accept any input of 6V DC to 30V DC and automatically reduce it to the 5.5V DC required for the invention to operate.

Still another objective of the invention is to provide a fingerprint authentication system that can be customized in individual application types including: automotive, motorcycle, powersport, and marine applications.

Still another objective of the invention is to provide a fingerprint authentication system device for use on a vehicle that allows multiple fingerprints to be stored, as well as provide a Valet Mode to temporarily deactivate the unit and allow access so that any user may operate the vehicle while in valet mode.

Another objective of the invention is to provide a wireless, handheld programmer to allow ease of programming with a console having indicator lights to indicate programming mode, successful programming entry, and Valet Mode.

Another objective of the invention is to provide a lower cost system wherein the cost of a passive capacitance resistance sensor is dramatically less than optic input devices.

Another objective of the invention is to replace the use of a conventional key for operating of a vehicle.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a flowchart of the fingerprint process of the instant invention;

FIG. 2 is a flowchart of the components used for the process shown in FIG. 1;

FIG. 3 is a chart depicting the various LED indicator light modes;

FIG. 4 is a chart depicting User Slot light patterns;

FIG. 5 is a perspective view of the sensor module;

FIG. 6 is pictorial view of sensor operation;

FIG. 7 is an electrical schematic of the controller;

FIG. 8 is an electrical schematic of the sensor LED controller; and

FIG. 9 is a perspective view of the remote programmer.

### DETAILED DESCRIPTION OF THE INVENTION

Disclosed below and depicted in the figures generally, is a fingerprint authentication system that can be used for security purposes and has a particular benefit for use in protecting vehicles, such as automotive, truck, general aviation aircraft, motorcycles, and marine vehicles, due to its ability to provide a high level of security in a compact device having a robust architecture that, at the same time, is simple to install. The fingerprint authentication system employs a wireless handheld programmer (90) for easy setup and configuration. A multifactor security authentication sensor console (22) includes the use of multicolor LED indicator lights (42) that provide programming and user interface feedback by universal symbols, such as patterns of colored lights, which can easily be understood by any language.

The fingerprint authentication system of the instant invention is electrically coupled to the electrical starter of the vehicle and/or the body control module that processes the starter function of the vehicle. Once the operator's identity has been authenticated, the device allows operation of the electrical starter for starting of the engine. The embodiment of the fingerprint authentication system disclosed can identify up to 72 fingerprints allowing multiple users to operate the vehicle. A Valet Mode is provided wherein the unit can be temporarily deactivated or programmed to allow any user access to operate the vehicle for a limited time. The sensor microprocessor (24), together with the sensor window (40), operates as a swipe and therefore the sensor console (22) consumes very little space, which allows for inconspicuous placement on most any sized vehicle.

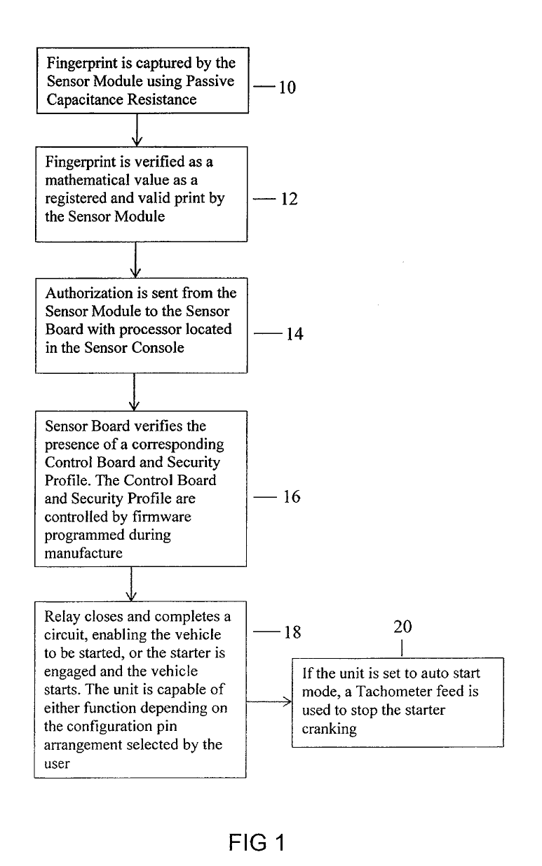

Referring to FIG. 1, in general the process of the system is to capture a fingerprint by a passive capacitance resistance sensor (10). The fingerprint is then verified as a mathematical value (12). Authorization is sent from a microprocessor coupled to the swipe window to a proprietary sensor board (14), the sensor board then verifies the presence of a corresponding control board with a control board security profile (16). If the fingerprint is authorized a relay is closed, starting the vehicle or enabling the vehicle to be started (18). If the unit is set to an auto start mode, a tachometer feed is used to detect and stop starter cranking after the vehicle has been started (20).

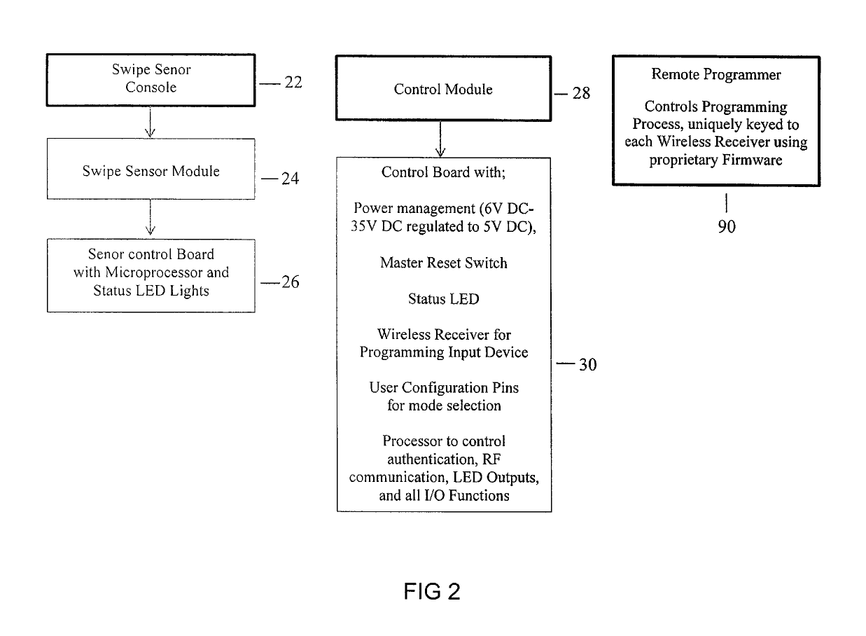

FIG. 2 depicts the sensor console (22) having a swipe sensor microprocessor (24) and sensor control board (26). The control board module (28) has a control board (30) with a microprocessor to control authentication, a receiver for a programming input device, and a relay coupled to the vehicle ignition circuit. A wireless remote programmer (90) provides for programming control.

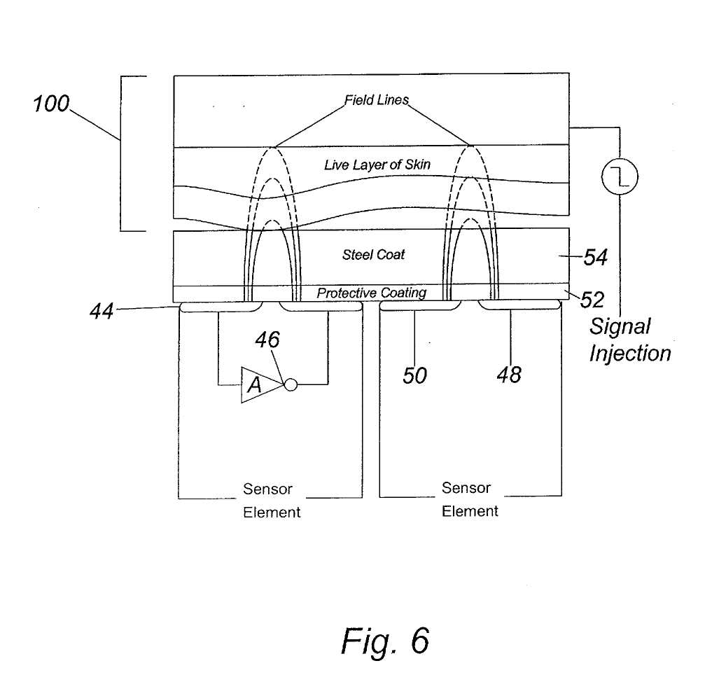

Passive capacitance resistance scanning is accomplished by a swipe of a finger (100) across the sensor window (40) on the surface of the sensor console (22) coupled to a sensor microprocessor (24). The sensor module (24) is used to measure the passive capacitance of the fingerprint patterns on the dermal layer of skin. Referring to FIG. 6, each sensing element (44) is used to measure the capacitance at that point of the array, the capacitance varies between the ridges and valleys of the fingerprint since the volume between the valleys of the dermal layer and the sensing element contains an air gap. The dielectric constant of the epidermis and the area of the sensing element are known values. The measured capacitance values are then used to distinguish between fingerprint ridges and valleys. Each sensing element (44) in the array of sensing elements act as one plate of a parallel-plate capacitor while the electrically conductive dermal layer acts as the other plate. The non-conductive epidermal layer acts as a dielectric.

The system relies on a passive capacitance resistance method which is more desirable to use than an optical method because it is harder to “spoof” authentication. Passive capacitance resistance does not store an image of a fingerprint and requires a “live” finger to be used.

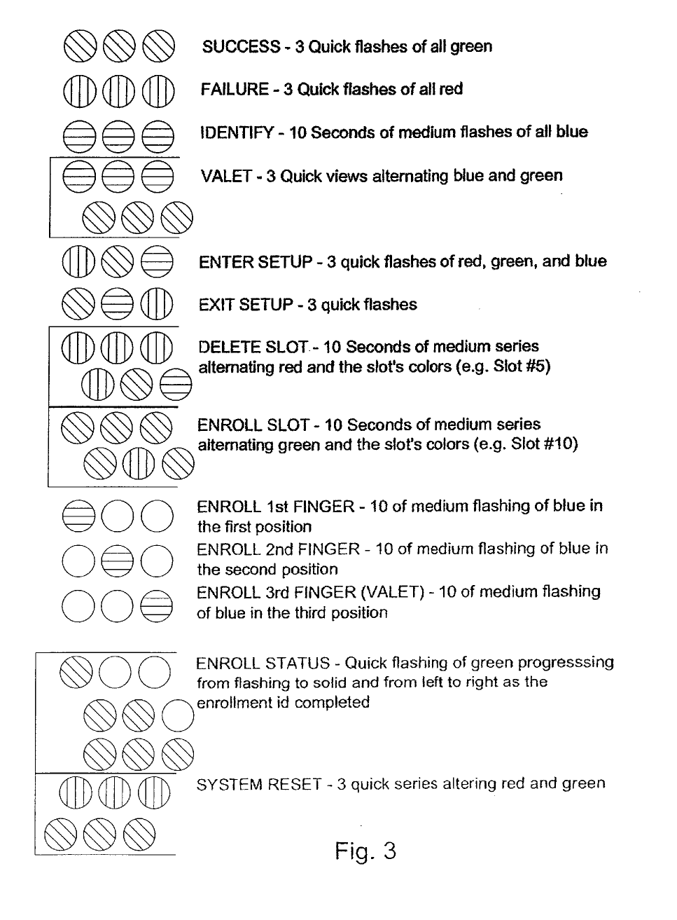

First Time Enrollment Procedure: Referring to FIG. 3, when the device is started for the first time, or after a Master Reset, the device has no user enrollments so it will immediately go into Enrollment Mode for the master user as indicated by the first LED indicator light (42) blinking Blue (indicator mode 9). The master user will be required to enroll three separate fingers. The first finger is the primary, the second finger is a backup, and the third finger is for Valet Mode.

Enrollment Mode: For every user three fingers must be enrolled. Once the unit has started enrolling the unit will indicate which of the three fingers to be enrolled needs to be provided by blinking the LED indicator light (42) Blue for that position (i.e., 1, 2, and/or 3)(indicator modes 9, 10, and 11). When the LED indicator light (42) is blinking Blue for a given finger (indicator mode 9, 10, or 11), the appropriate finger is then swiped repeatedly. As the finger is swiped, LED indicator lights (42) will indicate the percentage complete by flashing Green then turning solid in sequence from left to right (indicator mode 12). When the finger is complete the unit will indicate the next finger by flashing the appropriate LED indicator light (42) in Blue (indicator mode 10 or 11) and the operator can begin the next finger. The third finger is the Valet Mode finger and MUST be different from the first and second fingers. After all three fingers are complete the LED indicator lights (42) will flash all Green (indicator mode 1).

Normal operating Mode. Once all three fingers are complete the LED indicator lights (42) will flash all Green (indicator mode 1). Should a failure occur, three quick flashes of the LED indicator lights (42) in all Red will take place (indicator mode 2). When power is applied to the device it will automatically go into Identification Mode as indicated by the LED indicator lights (42) flashing all Blue (indicator mode 3). The operator would then swipe a registered finger and the LED indicator lights (42) will display three flashes of Green (indicator mode 1) to indicate a successful reading wherein a relay will be energized connecting the vehicle ignition to the battery source. If the finger is not identified, indicated by the LED indicator lights (42) displaying three flashes of Red (i.e., failure) (indicator mode 2), the unit will immediately return to Identification Mode for two more attempts, a total of three attempts are possible. After three attempts the unit must be powered off and back on to reattempt identification.

Entering Valet Mode: When power is applied to the device it will automatically go into Identification Mode as indicated by the LED indicator lights (42) flashing all Blue (indicator mode 3). A Valet Mode finger can then be swiped and the LED indicator lights (42) will flash alternating Blue/Green (indicator mode 4) and a Relay (62) would then be closed, connecting the ignition to the battery source. If the finger is not identified, as indicated by the LED indicator lights (42) displaying three flashes of Red (indicator mode 2), the unit will immediately return to Identification Mode for two more attempts, a total of three attempts are permitted. After three attempts the unit must be powered off and back on to reattempt identification. Once the Valet Mode is engaged, the unit will automatically connect the Relay (62) allowing startup of the vehicle and the LED indicator lights (42) will flash Blue/Green (indicator mode 4) to indicate the unit is in Valet Mode.

Exiting Valet Mode: When power is applied to the device in Valet Mode the Relay will be automatically energized and the LED indicator lights (42) will alternately flash Blue/Green (indicator mode 4). The unit will then begin flashing the Identification indicator of all Blue (indicator mode 3). If a non-Valet, registered finger is swiped then the unit will exit Valet Mode. If the Identification Mode is allowed to timeout then the unit will remain in Valet Mode. Only a registered, non-Valet finger can exit Valet Mode.

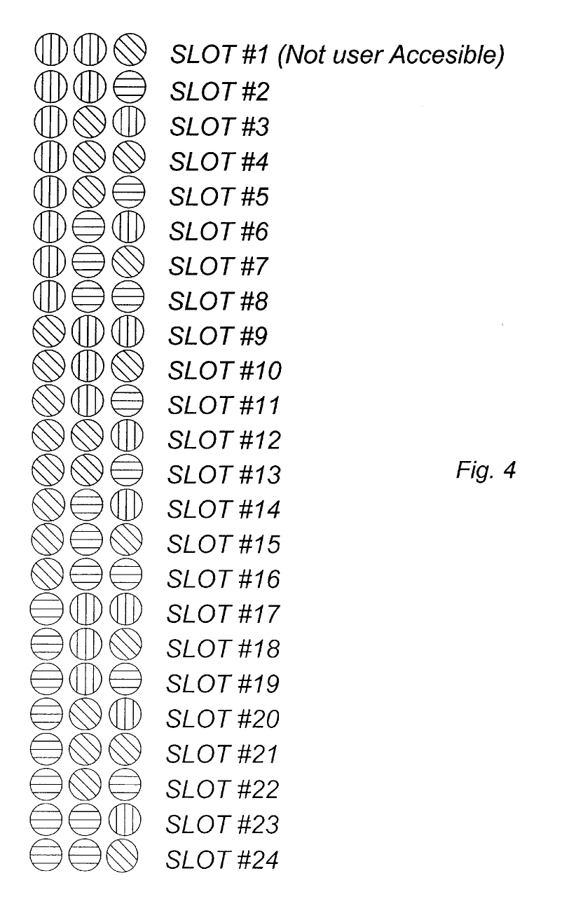

Adding/Deleting Users: With the unit running and no LED indicator lights (42) flashing, the operator presses a central button (92) on the remote programmer (90) to enter Setup. The LED indicator lights (42) will flash Blue (indicator mode 3) and require that a registered fingerprint is swiped. Once the fingerprint is identified the LED indicator lights (42) will quickly flash Red/Green/Blue (indicator mode 5) to indicate Setup Started and then show the second User Slot (Slot #2) ready, the first User Slot (Slot #1) is the default/master User Slot and cannot be edited. Using the remote programmer (90), oriented with the keychain hole down, the operator uses the left (99) and right (98) buttons to switch between the User Slots. As illustrated in FIG. 4, there are 23 accessible User Slots that can be selected and edited from Setup. To Delete a selected User Slot, the remote programmer (90) is used to switch between User Slots and the down button (96) is pressed so that the LED indicator lights (42) flash between the User Slot colors and all Red, indicating the User Slot will be deleted (indicator mode 7). The down button (96) on the remote (90) is pressed again to delete the selected User Slot or if the operator waits seconds the device will return to User Slot selection. To Enroll a user in a selected User Slot, the up button (94) is depressed and the LED indicator lights (42) will flash between the User Slot colors and all Green (indicator mode 8), indicating the User Slot will be enrolled. The up button (94) can be pressed again wherein the operator follows the Enrollment Mode process to enroll the new user.

Exit Setup: After each Delete or Enroll process the device will automatically exit Setup Mode. To manually exit Setup Mode, the center button (92) is pressed again and the LED indicator lights (42) will quickly flash Green/Blue/Red (indicator mode 6).

Master Reset for Deleting All Users: With the power off, a magnet is placed against a specified area on the external surface of the control board module (28), activating a reed switch. Upon the application of power to the control board module (28), the three LED indicator lights (42) alternate Red/Green (indicator mode 13) and then stop flashing, the power is then turned off and back on to restart. When the device is restarted with no enrollments it will immediately go into Enrollment Mode for the master user as indicated by the first indicator light (42) blinking Blue (indicator mode 9).

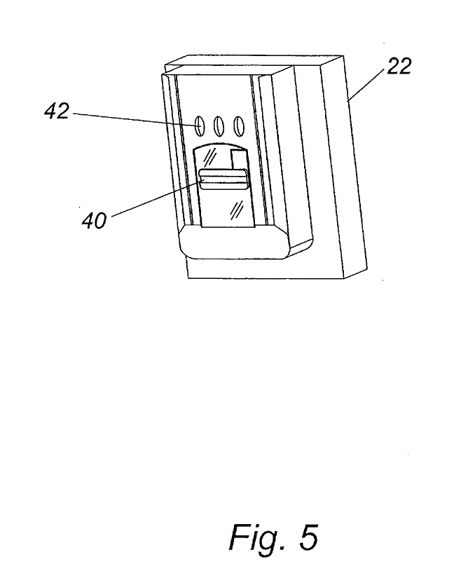

Now referring to FIGS. 5 and 6, set forth is the sensor console (22) having a swipe window (40) and three multicolor LED indicator lights (42) used for operational depiction. The swipe window (40) consists of a plurality of sensing elements (44), each with a bridged amplifier (46), a transmitter (48) and a receiver (50), wherein each sensing element (44) in the array acts as one plate in a parallel plate capacitor, the dermal layer of the finger (100) acts as the other plate, and the epidermis acts as a dielectric. The array of sensing elements (44) is placed beneath a protective coating (52) and steel coat (54). A finger swipe occurs when a finger (100) is drawn across the sensor window (40) wherein field lines are graphically illustrated to show how the transmission uses the conductively of the skin for depicting surface structure of the finger (100).

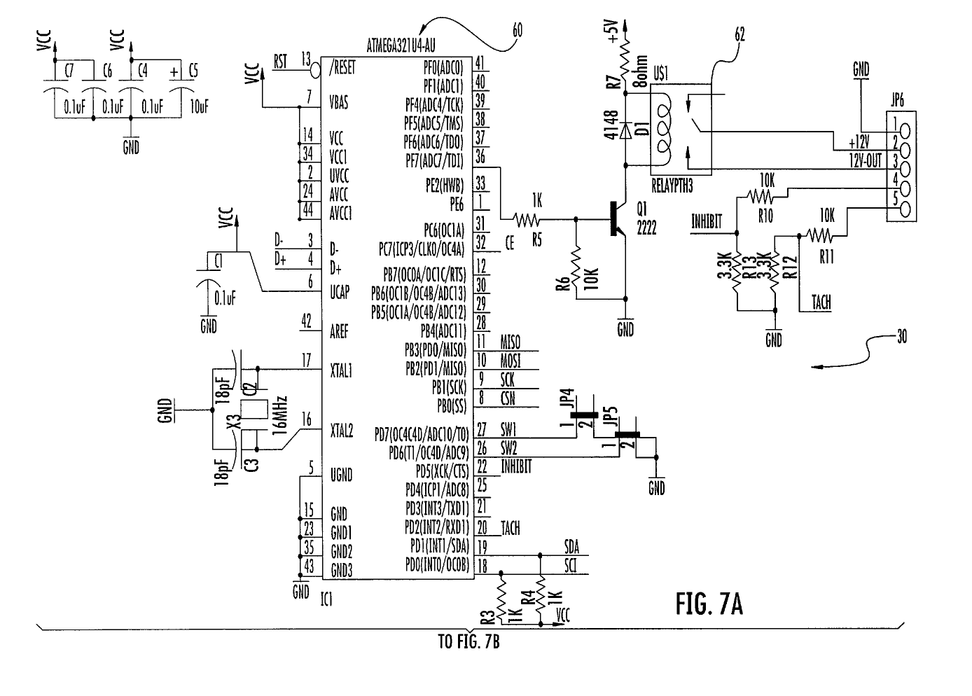

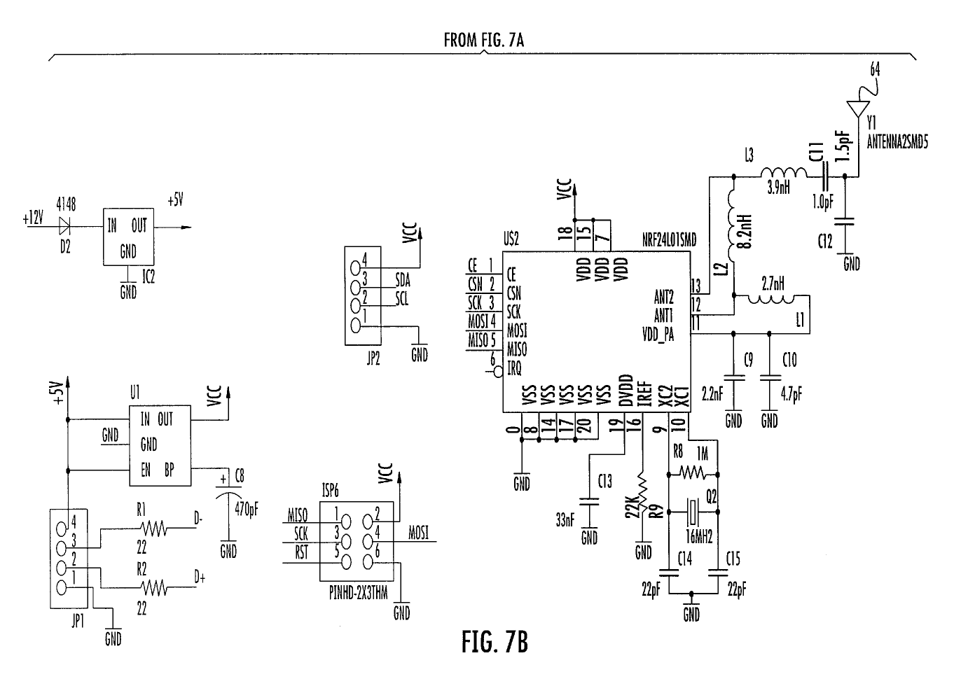

FIG. 7 is the electrical schematic for the microprocessor (60) used in the control board (30). The microprocessor (60), here an Atmet1 ATMega42U4 used in the low power consumption 3.3V operating mode, is used to operate the relay (62) for allowing operation of a vehicle. In an exemplary embodiment the vehicle's ignition wire is interrupted on the primary low voltage side of the vehicle's starter relay and the relay of the instant invention is connected to replace the vehicle's key in the ignition process. This process can alternatively be used to interrupt any 12V circuit in the vehicle. The processor controls authentication of the security profile for each registered user, radio frequency communication through the antenna (64), and communicates with the sensor control board (26) to control LED outputs and all input/output functions. Two jumper pins are depicted on the control board microprocessor (60) for alternating between the 4 modes of operation. By way of illustration, the controller and relay interface for an ignition based vehicle is preferably programmed as follows:

```
Controller Unit: Atmel-Fist/Fist_Controller_V1
Fist_Controller_V1.pde - Main sketch file
FistCommands.h - I2C Messaging Definitions
ControllerHardware.cpp - Functions for hardware functions for
buttons, jumpers, and messaging
ControllerHardware.h - Header for hardware functions for
buttons, jumpers, and messaging
The changes for an address of 0x00 0x000x00 0x01 would look
like...
  //Set Wireless Address ***MUST BE UNIQUE AND MATCH WITH
  FOB
  byte rx_addr[5] = {0x00, 0x00, 0x00, 0x01, 0xE7};
//Wireless Address must match Controller
data_array[0] = 0x00;
data_array[1] = 0x00;
data_array[2] = 0x00;
data_array[3] = 0x01;
tx_send_payload(0x30); //Set TX address
The changes for an address of 0xF0 0xE0 0xD0 0x87 would look
like...
  //Set Wirelss Address ***MUST BE UNIQUE AND MATCH WITH
  FOB
  byte rx_addr[5] = {0xF0, 0xE0, 0xD0, 0x87, 0xE7};
//Wireless Address must match Controller
data_array[0] = 0xF0;
data_array[1] = 0xE0;
data_array[2] = 0xD0;
data_array[3] = 0x87;
tx_send_payload(0x30); //Set TX address
With respect to SW1 and SW2, each of these pins corresponds to a
bit value of SW1=1 and SW2=2. Using bitwise OR of the two
values we get one of the following combinations and functions:
#define START_ON 0 - Relay comes on and stays on (same behavior
as moto units)
#define START_30 1 - Relay comes on for 30 seconds and then goes
off
#define START_SWITCH 2 - Relay comes on until the SWITCH pin is
set HIGH
#define START_1K 3 - Relay comes on until the SWITCH pin is
pulsed HIGH at a frequency of 500rpm (value is set on line 376
of Fist_Controller_V1.pde)
Key Fob:
nordic-nRF24L01.c - device specific functions
Nordic-FOB-v11.c - core Nordic functions
#include <stdio.h>
#include <avr/io.h>
#include <avr/interrupt.h>
#include <avr/sleep.h>
#define sbi(var, mask)  ((var) |= (uint8_t)(1 << mask))
#define cbi(var, mask)  ((var) &= (uint8_t)~(1 << mask))
//Define functions
//======================
void ioinit(void);  //Initializes IO
void delay_ms(uint16_t x); //General purpose delay
void delay_us(uint8_t x);
uint8_t data_array[4];
#include “nordic-nRF24L01.c”
//======================
ISR(PCINT0_vect){ //This vector is only here to wake unit up
from sleep mode}
int main (void)
{uint16_t button_presses = 0;
ioinit( );
transmit_data( ); //Send one packet when we turn on
while(1)
{if( (PINA & 0x8F) != 0x8F )
{button_presses++;
            data_array[0] = PINA & 0x0F;
            data_array[0] |= (PINA & 0x80) >> 3;
            data_array[1] = button_presses>> 8;
            data_array[2] = button_presses& 0xFF;
            data_array[3] = 0;
            transmit_data( );
        tx_send_command(0x20, 0x00); //Power down RF
        cbi(PORTB, TX_CE); //Go into standby mode
        sbi(PORTB, TX_CSN); //Deselect chip
        ACSR = (1<<ACD); //Turn off Analog Comparator - this
removes about 1uA
        PRR = 0x0F; //Reduce all power right before sleep
        delay_ms(600);
        asm volatile (“sleep”);
        //Sleep until a button wakes us up on interrupt
    return(0);
void ioinit (void)
      //1 = Output, 0 = Input
    DDRA = 0xFF & ~(1<<TX_MISO | 1<<BUTTON0 |
1<<BUTTON1 | 1<<BUTTON2 | 1<<BUTTON3 | 1<<BUTTON4);
    DDRB = 0b00000110; //(CE on PB1) (CS on PB2)
    //Enable pull-up resistors (page 74)
    PORTA = 0b10001111; //Pulling up a pin that is grounded
will cause 90uA current leak
    cbi(PORTB, TX_CE); //Stand by mode
    //Init Timer0 for delay_us
    TCCR0B = (1<<CS00); //Set Prescaler to No Prescaling (assume
we are running at internal 1MHz). CS00=1
    DDRA = 0xFF;
    DDRB = 0xFF;
    while (1)
        PORTA = 0xFF;
        PORTB = 0xFF;
        delay_ms(3000);
        PORTA = 0x00;
        PORTB = 0x00;
        delay_ms(3000);
    configure_transmitter( );
    GIFR = (1<<PCIF0); //Enable the Pin Change interrupts to
monitor button presses
    GIMSK = (1<<PCIE0); //Enable Pin Change Interrupt Request
    PCMSK0 =
(1<<BUTTON0)|(1<<BUTTON1)|(1<<BUTTON2)|(1<<BUTTON3)|
(1<<BUTTON4);
    MCUCR = (1<<SM1)|(1<<SE); //Setup Power-down mode and
enable sleep
    sei( ); //Enable interrupts
//General short delays
void delay_ms(uint16_t x)
    for (; x > 0 ; x−−)
        delay_us(250);
        delay_us(250);
        delay_us(250);
        delay_us(250);
//General short delays
void delay_us(uint8_t x)
    TIFR0 = 0x01; //Clear any interrupt flags on Timer2
    TCNT0 = 256 − x; //256 − 125 = 131 : Preload timer 2 for x
clicks. Should be 1us per click
    while( (TIFR0 & (1<<TOV0)) == 0).
```

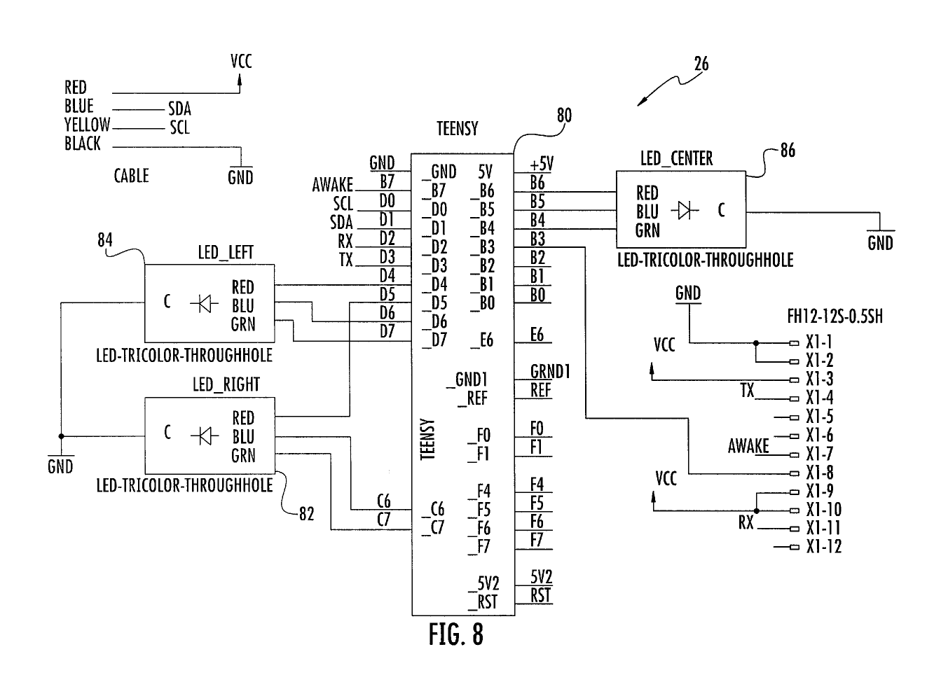

FIG. 8 is the electrical schematic for the microprocessor (80) used in the sensor control board (26). The microprocessor (80) currently used is a Teensy programmed to operate the tricolored LED (Red/Blue/Green) indicator lights (82, 84, and 86).

### Sensor Unit: Atmel—Fist/Fist_V1

Fist_V1.pde—Main sketch file
Hardware.h—Header for hardware functions for blinking and biometrics
Hardware.cpp—Functions for blinking and biometrics
FistCommands.h—I2C Messaging Definitions
Pins.h—Mapping of GPIO pins

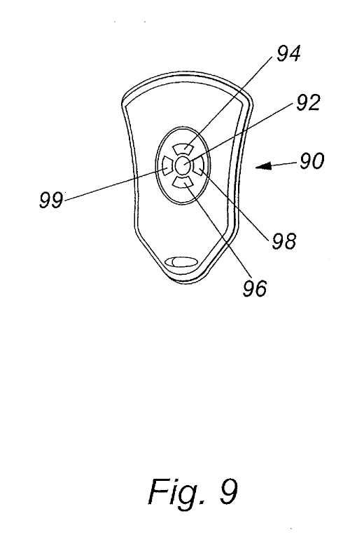

FIG. 9 is a perspective view of a remote programmer (90) which is a wireless KeyFob. The remote programmer (90) provides the previously mentioned programming process where each controller is uniquely keyed to the particular system by a proprietary firmware. The remote programmer (90) uses a central button (92) for entering a location depiction, the location movement caused by directional buttons (94, 96, 98, and 99). The controller is preferably programmed as follows:

Basic routines for nRF24L01

| | |
|---|---|
| #define TX_PORT | PORTA |

#define TX_PORT_PIN PINA
#define TX_PORT_DD DDRA
#define TX_SCK 4 //Output
#define TX_MISO 5 //Input

| | |
|---|---|
| #define TX_MOSI | 6 //Output |

#define TX_CE 1 //Output
#define TX_CSN 2 //Output

| | |
|---|---|
| //#define RF_DELAY | 5 |
| #define RF_DELAY | 55 |
| #define BUTTON0 | 0 |
| #define BUTTON1 | 1 |
| #define BUTTON2 | 2 |
| #define BUTTON3 | 3 |
| #define BUTTON4 | 7 |

```
//2.4G Configuration - Transmitter
uint8_t configure_transmitter(void);
//Sends command to nRF
uint8_t tx_send_byte(uint8_t cmd);
//Basic SPI to nRF
uint8_t tx_send_command(uint8_t cmd, uint8_t data);
//Sends the 4 bytes of payload
void tx_send_payload(uint8_t cmd);
//This sends out the data stored in the data_array
void transmit_data(void);
//Basic SPI to nRF
uint8_t tx_spi_byte(uint8_t outgoing);
//TX Functions
void transmit_data(void)
    tx_send_command(0x27, 0x7E); //Clear any interrupts
    tx_send_command(0x20, 0x7A); //Power up and be a
transmitter
    tx_send_byte(0xE1); //Clear TX Fifo
    tx_send_payload(0xA0); //Clock in 4 byte payload of
data_array
sbi(PORTB, TX_CE); //Pulse CE to start transmission
delay_ms(3);
cbi(PORTB, TX_CE);
//2.4G Configuration - Transmitter
//This sets up one RF-24G for shockburst transmission
uint8_t configure_transmitter(void)
cbi(PORTB, TX_CE); //Go into standby mode
    tx_send_command(0x20, 0x78); //CRC enabled, be a
transmitter
    tx_send_command(0x21, 0x00); //Disable auto acknowledge on
all pipes
    tx_send_command(0x24, 0x00); //Disable auto-retransmit
    tx_send_command(0x23, 0x03); //Set address width to 5bytes
(default, not really needed)
    tx_send_command(0x26, 0x07); //Air data rate 1Mbit, 0dBm,
Setup LNA
    tx_send_command(0x26, 0x01); //Air data rate 1Mbit, −18dBm,
Setup LNA
    tx_send_command(0x25, 0x02); //RF Channel 2 (default, not
really needed)
    //Wireless Address must match Controller
    data_array[0] = 0x00;
    data_array[1] = 0x00;
    data_array[2] = 0x00;
    data_array[3] = 0x05;
    tx_send_payload(0x30); //Set TX address
    tx_send_command(0x20, 0x7A); //Power up, be a transmitter
    return(tx_send_byte(0xFF));
//Sends the 4 bytes of payload
void tx_send_payload(uint8_t cmd)
    uint8_t i;
    cbi(PORTB, TX_CSN); //Select chip
    tx_spi_byte(cmd);
    for(i = 0 ; i < 4 ; i++)
        tx_spi_byte(data_array[i]);
    sbi(PORTB, TX_CSN); //Deselect chip
//Sends command to nRF
uint8_t tx_send_command(uint8_t cmd, uint8_t data)
    uint8_t status;
    cbi(PORTB, TX_CSN); //Select chip
    tx_spi_byte(cmd);
    status = tx_spi_byte(data);
    sbi(PORTB, TX_CSN); //Deselect chip
    return(status);
//Sends one byte to nRF
uint8_t tx_send_byte(uint8_t cmd)
uint8_t status;
    cbi(PORTB, TX_CSN); //Select chip
    status = tx_spi_byte(cmd);
    sbi(PORTB, TX_CSN); //Deselect chip
    return(status);
//Basic SPI to nRF
uint8_t tx_spi_byte(uint8_t outgoing)
    uint8_t i, incoming;
    incoming = 0;
//Send outgoing byte
    for(i = 0 ; i < 8 ; i++)
        if(outgoing & 0b10000000)
            sbi(TX_PORT, TX_MOSI);  else
        cbi(TX_PORT, TX_MOSI);
        sbi(TX_PORT, TX_SCK); //TX_SCK = 1;
        delay_us(RF_DELAY);
        //MISO bit is valid after clock goes going high
        incoming <<= 1;
        if( TX_PORT_PIN & (1<<TX_MISO) ) incoming |= 0x01;
        cbi(TX_PORT, TX_SCK); //TX_SCK = 0;
        delay_us(RF_DELAY);
    return(incoming);
```

The All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A method for selectively enabling the operation of a vehicle based upon biometric profiles comprising:
installing a controller having a biometric sensor with indicator lights coupled to a vehicle;
initiating enrollment of a first authorized user of the vehicle by illuminating a first of said indicator lights to indicate the need of a primary biometric profile;
swiping a first finger of an authorized user across said biometric sensor;
generating a primary biometric profile of said authorized user by measuring the passive capacitive resistance of said first finger wherein the controller assigns a numerical number to said profile;
repeatedly swiping of said first finger across said sensor window until three of said indicator lights are illuminated to confirm the biometric profile is acceptable and stored;
illuminating a second blinking indicator light to indicate the required enrollment of a secondary finger of the authorized user;
swiping the second finger across said sensor window in response to said second indicator light allowing measurement of the passive capacitive resistance of the secondary finger;
generating a secondary finger biometric profile of said authorized user by measuring the passive capacitive resistance of said second finger wherein the controller assigns a numerical number to said profile;
storing said primary and secondary biometric profile;
receiving an instant finger swipe across said sensor window and creating an instant biometric profile;
comparing the instant biometric profile against stored authorized users biometric profiles;
verifying said instant biometric profile to be equivalent to a least one stored authorized users biometric profile;
producing a signal upon receipt of a verified profile, said signal allowing identifying a corresponding security profile to allow operation of the vehicle.

2. The method for selectively enabling the operation of a vehicle based upon biometric profiles including:
illuminating a third indicator light to indicate a required enrollment of a valet biometric profile;
swiping a third finger across a sensor window in response to said indicator light and continue swiping the third finger until said three indicator lights are lit to indicate proper measurement of the passive capacitive resistance of said third finger;
generating a valet mode biometric profile based upon said third finger;
verifying a biometric profile of said third finger against a list of registered profiles;
indentifying a corresponding security profile associated with said registered profile; and
sending a command to a relay electrically coupled to a vehicle to allow operation of the vehicle by a non-authorized user.

3. The method for selectively enabling the operation of a vehicle based upon biometric profiles according to claim 1 wherein said indicator lights are tri-colored, a blue color indicates primary finger enrollment; a green color indicates fingerprint profiling and a red color indicates a possible failure.

4. The method for selectively enabling the operation of a vehicle based upon biometric profiles according to claim 1 wherein all three indicator lights blink red and for three times indicates a failure condition.

5. The method for selectively enabling the operation of a vehicle based upon biometric profiles according to claim 3 wherein a blinking indicator light indicates a processing condition.

6. The method for selectively enabling the operation of a vehicle based upon biometric profiles according to claim 3 wherein a steady on indicator light indicates a satisfied condition.

7. The method for selectively enabling the operation of a vehicle according to claim 1 based upon biometric profiles wherein a flashing green light indicates percentage complete.

8. The method for selectively enabling the operation of a vehicle according to claim 1 wherein said microprocessor has a programming means to compare finger swipes against pre-enrolled biometric profiles.

9. A biometric fingerprint identification device for selectively enabling a vehicle comprising:
a swipe sensor constructed and arranged to measure passive capacitance resistance and generate a biometric profile of a finger of an authorized user;
a microprocessor having a memory electrically coupled to said sensor, said microprocessor comparing a biometric profile against a list of registered biometric profiles stored in memory;
a control board having electrically coupled to said microprocessor having at least one security protocol to select a predetermined coding to produce an electrical signal;
at least one indicator light coupled to said control board to indicate enrollment conditions of said biometric profiles; and
a relay coupled to said control board and an ignition system circuit of a vehicle allowing the ignition of the vehicle to operate upon receipt of said electrical signal from said control board.

10. The biometric fingerprint identification device for selectively enabling a vehicle according to claim 9 wherein a security protocol is defined as a valet mode operation allows a secondary identification authorized by a registered user to permit a non-registered user to enable limited ignition of said vehicle.

11. The biometric fingerprint identification device for selectively enabling a vehicle according to claim 10 wherein said valet mode operation permits operation of said vehicle by an non-authorized user until said swipe sensor is operated by an authorized user.

12. The biometric fingerprint identification device for selectively enabling a vehicle according to claim 9, wherein said swipe sensor is constructed from a plurality of sensing elements coupled to a parallel plate capacitor each having a bridge amplifier, a transmitter, and a receiver, wherein the electrically conductive dermal layer of a finger acts as second plate when a finger is swiped across said swipe window wherein said bridge amplifier amplifies the a signal detected from said capacitor that is transmitted to the receiver for comparing the biometric profile against the list of registered biometric profiles stored in said memory.

13. The biometric fingerprint identification device for selectively enabling a vehicle according to claim 9 wherein said indicator light is further defined as indicator light panel having three tri-colored lights wherein a blue color indicates primary finger enrollment, a green color indicates fingerprint profiling and a red color indicates a possible failure.

14. The biometric fingerprint identification device for selectively enabling a vehicle according to claim 13 wherein all three indicator lights blink green to indicate an accepted position.

15. The biometric fingerprint identification device for selectively enabling a vehicle according to claim 13 wherein all three indicator lights blink red and for three times indicates a failure condition.

16. The biometric fingerprint identification device for selectively enabling a vehicle according to claim 13 wherein a blinking light indicates a processing condition.

17. The biometric fingerprint identification device for selectively enabling a vehicle according to claim 9 including a memory size to store about twenty four biometric profiles.
